(19) United States
(12) Patent Application Publication
(10) Pub. No.: US 2025/0053677 A1
(43) Pub. Date: Feb. 13, 2025

(54) DATABASE PROCESSING METHOD AND APPARATUS, DEVICE, AND MEDIUM

(71) Applicant: Beijing Volcano Engine Technology Co., Ltd., Beijing (CN)

(72) Inventor: Xinying Yang, Los Angeles, CA (US)

(21) Appl. No.: 18/797,307

(22) Filed: Aug. 7, 2024

(30) Foreign Application Priority Data
Aug. 7, 2023 (CN) 202310989108.7

(51) Int. Cl. G06F 21/62; G06F 21/60

(52) U.S. Cl. CPC G06F 21/6218; G06F 21/604; G06F 2221/2113; G06F 2221/2125; G06F 2221/2141

(57) ABSTRACT

The present disclosure relates to a database processing method and apparatus, a device, and a medium. The method includes: receiving an access request to a database, the access request carrying a user identifier of an accessor and a data processing instruction, wherein the database is deployed in an independent, safe execution environment; if a part of the target data is encrypted data, querying, based on the user identifier of the accessor, an authorization information table in the database, to detect whether the accessor is an authorized user of the part of the target data; and if the accessor is not an authorized user, performing mask processing on the part of the target data to generate invisible masked data, and returning the masked data and remaining unencrypted target data in the target data in response to the access request.

### CROSS-REFERENCE TO RELATED APPLICATION(S)

This application claims priority to Chinese Application No. 202310989108.7 filed on Aug. 7, 2023, the disclosure of which is incorporated herein by reference in its entirety.

### FIELD

The present disclosure relates to the technical field of data processing, in particular a database processing method and apparatus, a device, and a medium.

### BACKGROUND

According to current technology, the processing environment of a database is often unreliable and vulnerable to malicious attacks, risking the compromise and alteration of important data. To ensure data safety, multiple communications are required between the database, other security platforms, and users during data processing. For instance, a user encrypts data A and sends it to the database. The database decrypts data A, re-encrypts it, and sends the re-encrypted data A to another security platform. After the security platform decrypts data A, it re-encrypts it again and sends it back to the database. Such process of transmitting data A entails multiple communications and encryption/decryption operations. While effective for ensuring security, this approach compromises database processing efficiency and the flexibility of application processing

### SUMMARY

In order to solve, or at least partly solve, the above-mentioned technical problem, the present disclosure provides a database processing method and apparatus, a device, and a medium, to improve the data processing efficiency while ensuring the safety and reliability of data processing, and boost the data access flexibility.

Embodiments of the present disclosure provide a database processing method, comprising: receiving an access request to a database, the access request carrying a user identifier of an accessor and a data processing instruction, wherein the data processing instruction is used to instruct to process specified data in the database to obtain target data, and the database is deployed in an independent, safe execution environment; in a case that a part of the target data is encrypted data, querying, based on the user identifier of the accessor, an authorization information table in the database, to detect whether the accessor is an authorized user of the part of the target data, wherein the encrypted data comprises data stored in the database in an encrypted form, and the authorization information table is used to record authorized user information configured by a data provider for the encrypted data; and in a case that the accessor is not an authorized user of the part of the target data, performing mask processing on the part of the target data to generate invisible masked data, and returning the masked data and remaining unencrypted target data in the target data in response to the access request.

The embodiments of the present disclosure further provide a database processing apparatus, comprising: a receiving module configured to receive an access request to a database, the access request carrying a user identifier of an accessor and a data processing instruction, wherein the data processing instruction is used to instruct to process specified data in the database to obtain target data, and the database deployed in an independent, safe execution environment; a detection module configured to, in a case that a part of the target data is encrypted data, query, based on the user identifier of the accessor, an authorization information table in the database, to detect whether the accessor is an authorized user of the part of the target data, wherein the encrypted data comprises data stored in the database in an encrypted form, and the authorization information table is used to record authorized user information configured by a data provider for the encrypted data; and a feedback module configured to, in a case that the accessor is not an authorized user of the part of the target data, perform mask processing on the part of the target data to generate invisible masked data, and return the masked data and remaining unencrypted target data in the target data in response to the access request.

The embodiments of the present disclosure further provide an electronic device, comprising: a processor; and a memory configured to store executable instructions by the processor; wherein the processor is configured to read the executable instructions from the memory, and execute the executable instructions to implement the method provided by the embodiments of the present disclosure.

The embodiments of the present disclosure further provide a computer readable storage medium, wherein the computer readable storage medium has stored thereon computer programs for performing the method provided by the embodiments of the present disclosure.

The solutions provided by embodiments of the present disclosure have the following advantages over the prior art.

The database processing solution provided by the embodiments of the present disclosure includes: receiving an access request to a database, the access request carrying a user identifier of an accessor and a data processing instruction, where the data processing instruction is used to instruct to process specified data in the database to obtain target data, and the database is deployed in an independent, safe execution environment; in a case that a part of the target data is encrypted data, querying, based on the user identifier of the accessor, an authorization information table in the database, to detect whether the accessor is an authorized user of the part of the target data, where the encrypted data comprises data stored in the database in an encrypted form, and the authorization information table is used to record authorized user information configured by a data provider for the encrypted data; and in a case that the accessor is not an authorized user of the part of the target data, performing mask processing on the part of the target data to generate invisible masked data, and returning the masked data and remaining unencrypted target data in the target data in response to the access request.

According to the embodiments of the present disclosure, the database is fully encapsulated into an independent, safe execution environment, to thus achieve integration of the database and the safe execution environment and isolate related data in the safe execution environment. In this way, data security can be ensured, the interaction between the user and the database becomes more convenient, and the data processing efficiency can be improved since the user does not need to retransmit the encrypted data, nor is the database required to perform cumbersome data interaction with other security platform. Moreover, in the present solutions, target data is determined based on a data processing instruction sent by the accessor, and then subjected to encryption detection. If a part of the target data is encrypted data, authorization detection is performed on the part of data based on the authorization information table of the user identifier of the accessor, and if the part of data fails the authorization detection, the data is fed back to the user after performing mask processing on the part of data not permitted to view among the target data, thus ensuring the safety and efficiency of the data processing. In the case, unencrypted data in the target data can be fed back to the accessor, guaranteeing that unauthorized users can view some less confidential data, and improving the application flexibility of data processing scenarios.

### BRIEF DESCRIPTION OF THE DRAWINGS

The above and other features, advantages, and aspects of the present disclosure will become more apparent, through the following implementations with reference to the accompanying drawings. Throughout the drawings, the same or similar reference symbols refer to the same or similar components. It would be appreciated that the drawings are provided exemplarily, where the components and elements are not necessarily drawn to scale.

FIG. 1 illustrates a flowchart of a database processing method provided by embodiments of the present disclosure;

FIG. 2 illustrates a schematic diagram of a database processing scenario provided by embodiments of the present disclosure;

FIG. 3 illustrates a schematic diagram of a further database processing scenario provided by embodiments of the present disclosure;

FIG. 4 illustrates a schematic diagram of a structure of a database processing apparatus provided by embodiments of the present disclosure; and

FIG. 5 illustrates a schematic diagram of a structure of an electronic device provided by embodiments of the present disclosure.

### DETAILED DESCRIPTION OF EMBODIMENTS

Reference now will be made to the drawings to describe in detail the embodiments of the present disclosure. Although the drawings show some embodiments of the present disclosure, the present disclosure can be implemented in various forms, which should not be construed as being confined to the embodiments illustrated therein. Instead, those embodiments are provided only to enable those skilled in the art to understand the present disclosure more thoroughly and completely. It would be appreciated that the drawings and embodiments of the present disclosure are provided exemplarily, without suggesting any limitation to the protection scope of the present disclosure.

It is to be understood that respective steps in the implementations of the method according to the present disclosure may be performed in different orders and/or performed in parallel. In addition, the method implementations may include additional steps and/or steps omitted. The scope of the present disclosure is not limited thereto.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second” and the like mentioned in the present disclosure are only used to distinguish different apparatuses, modules or units, rather than limit an order of functions performed by the apparatus, module or unit or limit interdependence.

It should be noted that, the terms “one” and “a plurality of” mentioned in the present disclosure are illustrative, not restrictive, and should be understood as “one or more” by those skilled in the art, unless explicitly specified otherwise in the context.

Names of messages or information interacted between a plurality of apparatuses in the embodiments of the present disclosure are illustrative rather than limit the scope of the messages or information.

In order to solve the above problem, the embodiments of the present disclosure provide a database processing method.

In the method, a database is deployed in an independent, safe execution environment, specifically in a Trusted Execution Environment (TEE). Wherein, the TEE is a safe region of device hardware or software, which is isolated from a main operating system and provides a trusted environment for executing sensitive or crucial code and data. The safety of the TEE is mainly dependent on isolation from the main operating system and hardware protection measures, and the database is deployed in a trusted hardware-based trusted execution environment. The TEE provides a safe execution environment, and code and data stored and executed therein are protected. The TEE per se is comprised of special hardware in the processor, and can prevent, by means of some safety protection mechanisms, outsiders from tampering with or stealing the code and data in the TEE. Moreover, the TEE does not allow a common application to access the code and the data therein, thereby improving the system safety. Therefore, the TEE is an ideal platform for applications for, for example, encryption, digital security, security authentication, and the like. In the embodiments of the present disclosure, a database is completely encapsulated in the execution environment, to thus achieve integration of the database and the execution environment and isolate related data in the execution environment. In this way, data security can be ensured, the interaction between the user and the database becomes more convenient, and the data processing efficiency can be improved since the user does not need to retransmit the encrypted data, nor is the database required to perform cumbersome data interaction with other security platform.

Hereinafter, reference will be made to the embodiments to describe the method.

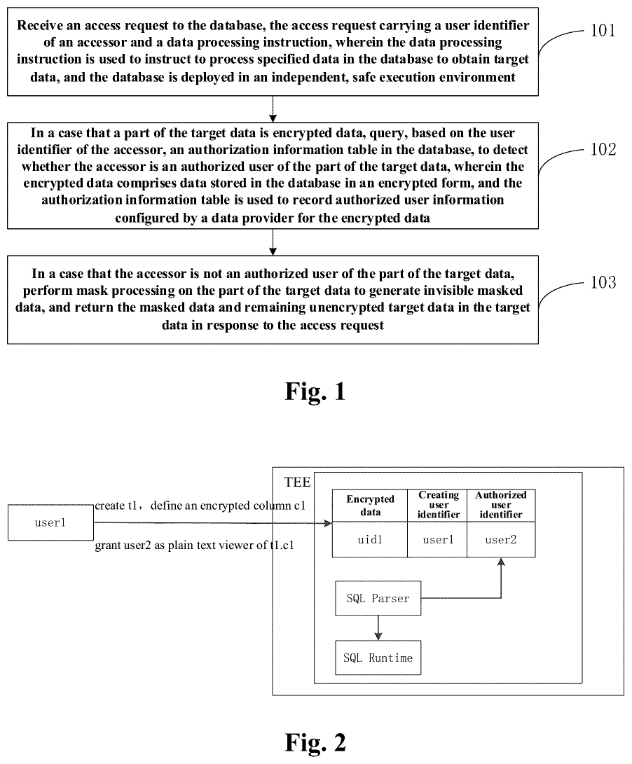

FIG. 1 illustrates a flowchart of a database processing method provided by embodiments of the present disclosure. The method can be performed by a database processing apparatus, where the apparatus may be implemented using software and/or hardware, and integrated typically in an electronic device. As shown therein, the method includes the steps below.

Step 101: receive an access request to a database, the access request carrying a user identifier of an accessor and a data processing instruction, where the data processing instruction is used to instruct to process specified data in the database to obtain target data.

Wherein, the access request may be a request sent by a user to access data in the database, and may carry parameters required to access the data. The access request according to the embodiments of the present disclosure may include a user identifier of an accessor and a data processing instruction. The user identifier of the accessor may be a user identifier of an access user currently sending the access request, which is used to uniquely characterize the current access user. The data processing instruction can be used to instruct to process specified data in the database to obtain target data, which may be represented as Structured Query Language (SQL). The specified data may include all the data involved in the data processing instruction, and the target data may be data meeting the accessor's need and obtained by filtering the specified data in the database.

Specifically, after receiving the access request for the database, the data processing apparatus can parse the data processing instruction to obtain the specified data from the database, and filter the specified data to determine target data identifiers of target data meeting the accessor's needs. Wherein, user needs are varied with the application scenario. For example, the user needs may be retrieving, updating, deleting or filtering data in some databases, or the like.

In some possible embodiments, when the data processing instruction is a SQL statement, the select statement in the SQL statement may be used as a processing instruction, which may be “select*from t1, t4 where t4·c2−t1·c2,” for example. Therefore, the statement indicates that the target data corresponding to the user needs is data in the tables t1 through t4 the same as the data in column c2 of the table t1, and the target data identifiers include data identifiers of the data.

Step 102: in a case that a part of the target data is encrypted data, query, based on the user identifier of the accessor, an authorization information table in the database, to detect whether the accessor is an authorized user of the part of the target data, where the encrypted data comprises data stored in the database in an encrypted form, and the authorization information table is used to record authorized user information configured by a data provider for the encrypted data.

It would be appreciated that, to achieve integration of the database and the TEE, all the data in the database is encrypted in the TEE according to the embodiments of the present disclosure, where the encrypted data and the authorization information table are two types thereof.

The database processing apparatus may determine whether the target data is encrypted data, specifically by detecting, based on the target data identifiers, whether the target data includes the encrypted data stored in the database. The encrypted data is data in the database, which the TEE specifies to be encrypted for a data provider, and an encryption key corresponding to the data provider is used to perform encryption processing to generate encrypted data that requires authorized access, i.e., data stored in an encrypted form.

In some embodiments, the data processing method may further include: receiving a creation instruction sent by the data provider, where the creation instruction includes: a user identifier of the data provider, a data table identifier, and a specified, encrypted data identifier corresponding to the data table identifier; for the data table identifier and the data corresponding to the data identifier, using an encrypted key corresponding to the user identifier of the data provider and stored in the TEE, the data are encrypted to generate encrypted data, the specified, encrypted data identifier is added to the encrypted data field in a relationship table, and the user identifier of the data provider corresponding to the specified, encrypted data identifier is written into a creating-user field based on a mapping relationship between the encrypted data field and the creating-user field in the relationship table.

The creation instruction may be an instruction for creating encrypted data and storing a relationship table embodying a mapping relationship between the encrypted data and a creating user. The creation instruction may cover specific parameters required for creation, including a user identifier of a data provider, a data table identifier, and a specified, encrypted data identifier corresponding to the data table identifier, where the user identifier of the data provider is used to characterize a current creating user, the data table identifier represents a data table currently required to be encrypted, and the specified, encrypted data identifier corresponding to the data table identifier represents specific data to be encrypted on the data table to be encrypted. The encrypted key of the TEE can be set according to the scenario need. In general, the public key of the TEE can be broadcast to the accessor, or the like, to allow the accessor to decrypt the encrypted data according to the public key.

Subsequent to receiving the creation instruction sent by the data provider, the database processing apparatus can acquire, based on the data table identifier in the creation instruction, a corresponding data table in the database, obtain specified, encrypted data from the data table based on the specified, encrypted data identifier corresponding to the data table, and then encrypts the specified, encrypted data based on the encrypted key corresponding to the user identifier of the data provider in the TEE, to generate encrypted data. That is, in the present embodiment, only the specified, encrypted data are encrypted, rather than all the data in the data table, thus improving significantly the data encryption efficiency.

Further, the specified, encrypted data identifier is added in the encrypted data field of the relationship table configured in the database, and the user identifier of the data provider corresponding to the specified, encrypted data identifier is added in the creating-user field of the relationship table based on the mapping relationship between the encrypted data field and the creating-user field in the relationship table.

In some embodiments, after the relationship table is encapsulated in the TEE, whether the target data includes encrypted data stored in the database is detected based on the target data identifiers, i.e., without data interaction with the database, querying data can be directly carried out in the TEE, and in the present embodiment, the encrypted data field in the relationship table is queried based on the target data identifiers; if a part of the target data identifiers is queried in the encrypted data field, it is determined that a part of the target data is the encrypted data, or, if all the target data identifiers are queried in the encrypted data field, it is determined that all the target data is the encrypted data, or, if none of the target data identifiers is queried in the encrypted data field, it is determined that the target data does not contain encrypted data.

For example, in a case that the target data identifiers include 5 data identifiers, if 3 data identifiers therein are queried in the encrypted data field, it is determined that the part of the target data corresponding to the 3 data identifiers is the encrypted data; if all the data identifiers are queried in the encrypted data field, it is determined that all the target data is the encrypted data; if none of the 5 data identifiers is queried in the encrypted data field, it is determined that the target data does not contain encrypted data.

The authorization information table and the relationship table as described above may be the same table, or may not. The authorized user information includes therein at least one authorized user identifier, which indicates that at least one user corresponding to the at least one authorized user identifier are permitted to access the encrypted data.

In some embodiments, the database processing method may further include: receiving an authorization configuration instruction sent by the data provider, where the authorization configuration instruction carries a user identifier of the data provider, a data identifier of the target data, and a user identifier of an authorized user, and the authorization configuration instruction is used to instruct to configure that an authorized user is authorized to access the target data; in response to the authorization configuration instruction, recording, in the authorization information table, a corresponding relationship among the user identifier of the data provider, the data identifier of the target data, and the user identifier of the authorized user.

The authorization configuration instruction may be a specific instruction for configuring user information of authorized access to the encrypted data. The authorization configuration instruction may include an identifier of authorized data of the authorized access, and an identifier of authorized user and a user identifier of the data provider corresponding to the authorization data identifier, where the identifier of authorized data may be a data identifier of encrypted data requiring authorization to access, the identifier of the authorized user may be an identifier of a user permitted to access the encrypted data as described above, and the user identifier of the data provider may be an identifier of a user creating the encrypted data. In the embodiments of the present disclosure, configuring an authorized user for the above-mentioned target data is taken as an example. The authorization configuration instruction includes a data identifier of the target data, and a user identifier of an authorized user and a user identifier of the data provider corresponding thereto.

Upon receiving the authorization configuration instruction sent by the data provider, the database processing apparatus writes, based on a mapping relationship between the encrypted data field and the authorized user field in the authorization information table, the authorization data identifier corresponding to the authorized user identifier into the authorized user field, to indicate that a user corresponding to the authorized user identifier is permitted to access the encrypted data corresponding to the authorization data identifier, and writes the user identifier of the data provider into the creating-user field correspondingly to the authorization data identifier. When the authorization configuration instruction carries therein the user identifier of the data provider, the data identifier of the target data, and the user identifier of the authorized user, the user identifier of the authorized user is written into the authorized user field of the authorization information table correspondingly to the data identifier of the target user, and the user identifier of the data provider is written into the creating-user field of the authorization information table correspondingly to the data identifier of the target data, to record the corresponding relationship among the user identifier of the data provider, the data identifier of the target data, and the user identifier of the authorized user.

For a piece of target data of the data provider, user identifiers of multiple authorized users are configured in the authorization information table. The authorization information table may be dynamically updated with the authorization configuration instruction sent by the data provider. That is, user identifier(s) of one or more authorized users may be configured for target data in the authorization information table, to indicate that the one or more authorized users are permitted to access the target data. As described above, the authorized user identifier is written into the authorized user field correspondingly to the authorization data identifier. Accordingly, an authorized user identifier is written into the authorized user field correspondingly to the authorized data identifier, to indicate that only one user corresponding to the authorized user identifier is permitted to access the encrypted data corresponding to the authorized data identifier; or multiple authorized user identifiers are written to the authorized user field correspondingly to authorized user identifiers, to indicate that multiple users corresponding to multiple authorized user identifiers are permitted to access encrypted data corresponding to the authorization data identifier. That is, one or more authorized user identifiers can be written into the authorized user field corresponding to the authorization data identifier, to indicate user(s) corresponding to one or more authorized user identifiers are permitted to access encrypted data corresponding to the authorization data identifier.

In the embodiments of the present disclosure, upon detecting that a part of the target data is encrypted data, the database processing apparatus may query the authorization information table in the database, and acquire, based on the corresponding relationship among a user identifier of a data provider, data identifiers of the target data, and user identifiers of authorized users, user identifiers of authorized users corresponding to the part of the target data, to obtain a set of authorized user identifiers, i.e., obtain a set of authorized user identifiers in the authorized user field corresponding to data identifiers of the part of the target data. If a user identifier of an accessor is present in the set of authorized user identifiers, it is determined that the accessor is an authorized user permitted to view the part of the target data. Otherwise, if a user identifier of an accessor is not present in the set of authorized user identifiers, it is determined that the accessor is not an authorized user permitted to view the target data.

In some embodiments, the target data is at least one column of encrypted data corresponding to a specified column identifier in at least one data table, or the target data comprises at least one row of encrypted data corresponding to a specified row identifier in at least one data table, or the target data includes at least one encrypted data element corresponding to a specified column identifier and a specified row identifier in at least one data table. That is, the target data may include, but is not limited to, at least one column of encrypted data, at least one row of encrypted data, at least one encrypted data element, or the like, in at least one data table, which may be set according to the actual scenario's need.

Step 103: in a case that the accessor is not an authorized user of the part of the target data, perform mask processing on the part of the target data to generate invisible masked data, and returning the masked data and remaining unencrypted target data in the target data in response to the access request.

In some embodiments of the present disclosure, when detected that the accessor is not an authorized user, mask processing is performed on the part of the target data to generate invisible masked data, and the masked data and the remaining unencrypted target data in the target data are returned to the accessor. In the case, the unauthorized user can only obtain the unencrypted data, which means that data at low security levels may not be present in the encrypted form, reducing resource consumption for encryption processing, and the unauthorized user can query data at the low security levels but is not permitted to view encrypted data, which can flexibly meet the data processing need.

In some embodiments of the present disclosure, when the accessor is an authorized user of a part of target data, the target data is returned in response to an access request. That is, when detected that the accessor is an authorized user of a part of the target data, the target data may be fed back to the accessor, where the encrypted data for the part of the target data can be decrypted, specifically based on a decryption key corresponding to the data provider, and the part of decrypted target data and the unencrypted data are fed back to the accessor. Therefore, authorization check can be omitted, avoiding multiple encryptions and decryptions between the client and the database (for example, there is no need for encrypting the obtained target data and then transmitting the encrypted target data to the database, and encrypting, by the database, the target data and then transmitting the encrypted target data to a client where the accessor is located, or the like), which can improve the data processing efficiency, and only the encrypted data is decrypted for the accessor, ensuring the safety and reliability of data processing.

For example, as shown in FIG. 2, the creation instruction sent by the data provider user 1 specifies that the data object stored in the encrypted form in the data table is the c1 column in the t1 table; the data provider is the creating user, the user identifier of the data provider is user 1 (corresponding to “create t1, define an encrypted column c1” in FIG. 2); the data identifier uid1 in the c1 column in the t1 data table is added to the encrypted data field of the relationship table configured in the database, the user identifier user 1 of the data provider is added in the creating-user field of the relationship table; upon receiving the authorization configuration instruction (corresponding to “grant user2 as plain text view of t1·c1” in FIG. 2) sent by the data provider, the data identifier of the authorized target data is specified as uid1, and the user identifier of the authorized user is specified as user2; a corresponding relationship among the user identifier user 1 of the data provider, the data identifier uid1 of the target data, and the user identifier user2 of the authorized user is recorded in the authorization information table, i.e., the user identifier user2 of the authorized user is added to the authorized user field corresponding to the data identifier uid1 of the target data in the authorization information table.

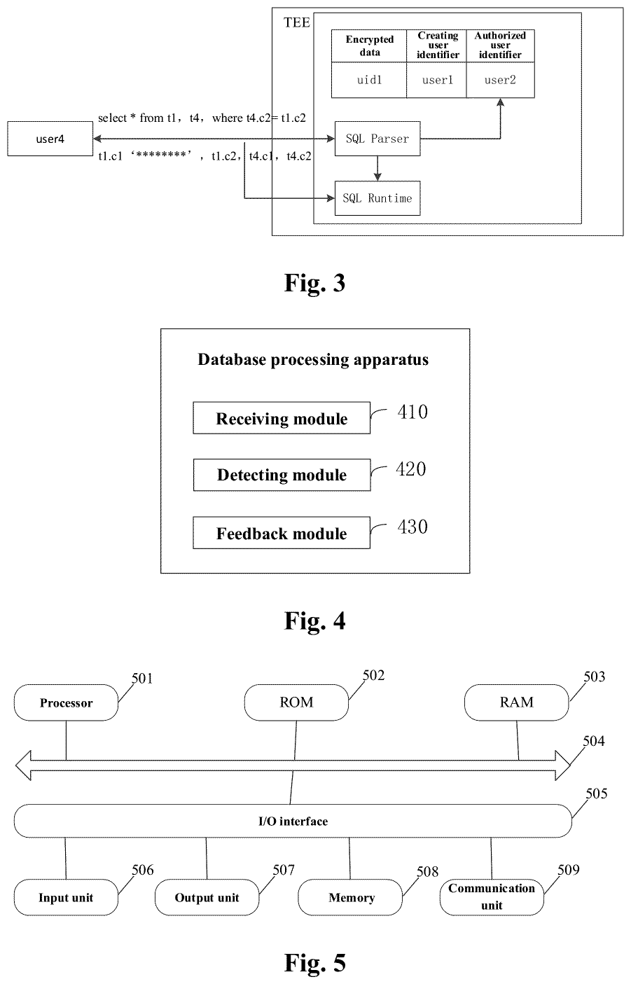

In the present embodiment, referring to FIG. 3, if the user identifier of the accessor is user4, the data processing instruction is “select*from t1, t4, where t4·c2=t1·c2” (i.e., target data equal to t1·c2 is selected from the tables t1-t4). Specifically, during execution, the processing instruction is converted into SQL syntax through an SQL Parser operation, and the corresponding syntax is executed through SQL Runtime, to query the encrypted data field in the relationship table based on the target data identifier of the target data. It is found that t1·c1 is the encrypted data. Therefore, the authorization information table is queried. User identifiers user2 of authorized users corresponding to the target user are obtained based on the corresponding relationship among the user identifier of the data provider, the data identifiers of target data, and user identifiers of authorized users, to obtain a set of authorized user identifiers, i.e., a set of authorized user identifiers user2 in the authorized user field corresponding to the target data identifiers is obtained. In the case, user4 is not the authorized user. If the target data includes t1·c1, t1·c2, t4·c1, and t4·c2, since t1·c1 is the encrypted data, mask processing is performed on t1·c1 to generate invisible masked data “********,” and the masked data and remaining unencrypted data returned to user4 is “t1·c1 ‘********,’ t1·c2, t4·c1, t4·c2.”

In the embodiments of the present disclosure, the Database Management System (DBMS) is encapsulated in the TEE (also referred to as TEE-DBMS integrated technology), where reading related conditional data of the client and the database, or the like, is implemented in the TEE. This technology is of a safe data processing architecture having TEE and DMS integrated densely therein, which can provide data security protection at higher levels. In the architecture, the TEE can be used to execute all SQL operations, including data creation, update, deletion, query, calculation, processing, and the like, to implement the complete database system function. The principle of the TEE-DBMS integrated technology is that the TEE is used to replace the legacy DBMS engine, and all the data operations are completed in the TEE. The TEE-DBMS integrated technology has the following advantages: 1. data confidentiality: the TEE can protect data confidentiality using secure computing technologies such as encryption, hashing, digital signature, and the like. Those technologies can prevent data leakage, tampering and forgery, and the like. 2. Data integrity: the TEE can provide robust data integrity protection mechanisms based on data structures, service rules, and the like. The mechanisms can prevent the data from being tampered with, lost and damaged during transmission, to thus guarantee the data integrity. 3. Fine-grained access control: the TEE can provide a flexible data access control strategy, which only allows authorized users to access data, and prevents unauthorized access and utilization. 4. Improved security: the DBMS is encapsulated in the TEE, which can reduce the attack surface and diminish security threads to the database system. The TEE also has autonomous security assessment and detection capabilities, and can further improve the security of the database system.

In some embodiments, target data may be acquired based on a data processing instruction sent by an accessor. When a part of the target data is encrypted data, authorization detection is performed for the part of the target data; mask processing is performed on the part of the target data not authorized to view, based on an authorization detection result, to guarantee the safety and reliability of data processing; the unencrypted target data can be fed back to the accessor to ensure that an unauthorized user can view some data at low security levels, thus improving the application flexibility of the data processing scenario while reducing the amount of the encrypted data and decreasing the encryption computing power for the encrypted data.

To conclude, the database processing solutions provided by embodiments of the present disclosure include: receiving an access request to the database, the access request carrying a user identifier of an accessor and a data processing instruction, where the data processing instruction is used to instruct to process specified data in the database to obtain target data, and the database is deployed in an independent, safe execution environment; in a case that a part of the target data is encrypted data, querying, based on the user identifier of the accessor, an authorization information table in the database, to detect whether the accessor is an authorized user of the part of the target data, where the encrypted data comprises data stored in the database in an encrypted form, and the authorization information table is used to record authorized user information configured by a data provider for the encrypted data; and in a case that the accessor is not an authorized user of the part of the target data, performing mask processing on the part of the target data to generate invisible masked data, and returning the masked data and remaining unencrypted target data in the target data in response to the access request. According to the embodiments of the present disclosure, the database is fully encapsulated into an independent, safe execution environment, to thus achieve integration of the database and the safe execution environment and isolate related data in the safe execution environment. In this way, data security can be ensured, the interaction between the user and the database becomes more convenient, and the data processing efficiency can be improved since the user does not need to retransmit the encrypted data, nor is the database required to perform cumbersome data interaction with other security platform. Moreover, in the present solutions, target data is determined based on a data processing instruction sent by the accessor, and then subjected to encryption detection. If a part of the target data is encrypted data, authorization detection is performed on the part of data based on the authorization information table of the user identifier of the accessor, and if the part of data fails the authorization detection, the data is fed back to the user after performing mask processing on the part of data without a view permission among the target data, thus ensuring the safety and efficiency of the data processing. In the case, unencrypted data in the target data can be fed back to the accessor, guaranteeing that unauthorized users can view some less confidential data, and improving the application flexibility of data processing scenarios.

In some embodiments of the present disclosure, the database processing method may further include: in a case that all of the target data are encrypted data, querying, based on the user identifier of the accessor, the authorization information table in the database, to detect whether the accessor is an authorized user of all of the target data; in a case that the accessor is the authorized user of all of the target data, returning all of the target data in response to the access request; or in a case that the accessor is not the authorized user of all of the target data, returning a processing failure notification message in response to the access request.

Upon detecting that all the target data is encrypted data, the database processing apparatus queries an authorization information table in the database based on a user identifier of an accessor, detects whether the accessor is an authorized user of all the target data specifically by querying the authorization information table, and acquires user identifiers of authorized users corresponding to all the target data based on a corresponding relationship among the user identifier of the data provider, data identifiers of target data, and user identifiers of authorized identifiers, to obtain a set of authorized user identifiers, i.e., to obtain a set of authorized user identifiers in the authorized user field corresponding to the data identifiers of all the target data. If the user identifier of the accessor is queried in the set of authorized user identifiers, it is determined that the accessor is an authorized user permitted to view all the target data. If the user identifier of the accessor is not queried in the set of authorized user identifiers, it is determined that the accessor is not an authorized user permitted to view all the target data. When the accessor is an authorized user to all the target data, all the target data is returned to the accessor in response to an access request, specifically after decrypting the target data; when the accessor is not an authorized user to all the target data, a processing failure notification message is returned in response to an access request. Wherein, the processing failure notification message may be set according to the scenario need, which is not limited herein. In this way, this can ensure that the encrypted data is fed back only to authorized users, and guarantee the safety and reliability of the data processing.

In some embodiments of the present disclosure, the authorization configuration instruction further includes: an access time limit for authorization, where the authorization information table specifically records a corresponding relationship among the user identifier of the data provider, the data identifier of the target data, the user identifier of the authorized user, and the authorized access time limit, and the access time limit for authorization is used to limit an access time of the authorized user to the target data.

The access time limit for authorization may be a time period set for encrypted data. Within the time period, access to the encrypted data is permitted; and if the time period is ended, access to the encrypted data is not permitted. The authorization configuration instruction according to the above embodiment may further include an access time limit for authorization which corresponds to the target data. The database processing apparatus can record, in the authorization information table, a corresponding relationship among the user identifier of the data provider, the data identifier of the target data, the user identifier of the authorized user, and the authorized access time limit, i.e., in addition to the user identifier of the authorized user, the access time limit for authorization of the data identifier of the target data is also written into the authorized user field of the target data corresponding to the data identifier of the target data in the authorization information table, indicating that the user corresponding to the user identifier of the authorized user is only permitted to access the target data within the access time limit for authorization.

When the access time limit for authorization corresponds to the authorized user identifier, the database processing device can record, in the authorization information table, a corresponding relationship among the user identifier of the data provider, the authorization data identifier, the authorized data identifier, and the access time limit for authorization, i.e., in addition to the authorization data identifier corresponding to the authorized user identifier, the access time limit for authorization of the authorized user identifier is also written into the authorized user field corresponding to the authorization data identifier in the authorization information table, indicating that the user corresponding to the authorized user identifier is only permitted to access the encrypted data corresponding to the authorization data identifier within the access time limit for authorization.

As discussed above, when detected that the accessor is an authorized user, the authorization information table can be queried to obtain an access time limit for authorization corresponding to the user identifier of the accessor in the authorized user field. Whether the current access time is within the access time limit for authorization corresponding to the user identifier of the accessor is determined. If yes, the data processing instruction is executed to process the target data to obtain the processed target data which can be returned in response to an access request; otherwise, a processing failure notification message is returned to the accessor. By prolonging the time limit for access, time verification is added for verifying the accessor's permission, to further improve the security of data processing.

In some embodiments of the present disclosure, the database processing method may further include: receiving an authorization deleting instruction sent by the data provider, the authorization deleting instruction carrying a user identifier of the data provider, a data identifier of the target data, and a user identifier of the authorized user, wherein the authorization deletion instruction is used to instruct to delete configuration information that the authorized user is authorized to access the target data; and in response to the authorization deletion instruction, deleting, from the authorization information table, a corresponding relationship among the user identifier of the data provider, the data identifier of the target data, and the user identifier of the authorized user.

The authorization deleting instruction may be an instruction for deleting user information of authorized access configured for the encrypted data. The authorization deleting instruction includes a user identifier of an authorized user to be deleted, and may include a data identifier of data to be deleted and a user identifier of a corresponding data provider. In the embodiments of the present disclosure, data to be deleted is taken as an example of the target data. In the circumstance, the authorization deleting instruction may further include a data identifier of target data and a user identifier of a data provider.

The data processing apparatus receives an authorization deleting instruction sent by the data provider, and, in response to the authorization deleting instruction, deletes at least one of the user identifier of the data provider, the data identifier of the target data, and the user identifier of the authorized user in the authorization information table, to delete the corresponding relationship among the user identifier of the data provider, the data identifier of the target data, and the user identifier of the authorized user. This solution supports deletion of configuration information of an authorized user permitted to access target data, making it possible to configure permissions to data more flexibly, which is in line with the actual service need.

In order to implement the above-mentioned embodiments, the present disclosure further provides a database processing apparatus. FIG. 4 illustrates a schematic diagram of a structure of a database processing apparatus provided by embodiments of the present disclosure. The apparatus can be implemented by software and/or hardware, which is typically integrated in an electronic device for database processing. As shown in FIG. 4, the apparatus includes: a receiving module 410, a detection module 420, and a feedback module 430, specifically.

The receiving module 410 may be configured to receive an access request to the database, the access request carrying a user identifier of an accessor and a data processing instruction, where the data processing instruction is used to instruct to process specified data in the database to obtain target data, and the database deployed in an independent, safe execution environment;

The detecting module 420 may be configured to, in a case that a part of the target data is encrypted data, query, based on the user identifier of the accessor, an authorization information table in the database, to detect whether the accessor is an authorized user of the part of the target data, where the encrypted data comprises data stored in the database in an encrypted form, and the authorization information table is used to record authorized user information configured by a data provider for the encrypted data; and

The feedback module 430 may be configured to, in a case that the accessor is not an authorized user of the part of the target data, perform mask processing on the part of the target data to generate invisible masked data, and return the masked data and remaining unencrypted target data in the target data in response to the access request.

Alternatively, the apparatus further includes a first returning module for:
in a case that the accessor is an authorized user of the part of the target data, returning the target data in response to the access request.

Alternatively, the apparatus further includes a second returning module for:
in a case that all of the target data are encrypted data, querying, based on the user identifier of the accessor, the authorization information table in the database, to detect whether the accessor is an authorized user of all of the target data;
in a case that the accessor is the authorized user of all of the target data, returning all of the target data in response to the access request; or
in a case that the accessor is not the authorized user of all of the target data, returning a processing failure notification message in response to the access request.

Alternatively, the apparatus further includes an authorization configuration module for:
receiving an authorization configuration instruction sent by the data provider, the authorization configuration instruction carrying a user identifier of the data provider, a data identifier of the target data, and a user identifier of the authorized user, where the authorization configuration instruction is used to instruct to configure the authorized user to be authorized to access the target data; and
in response to the authorization configuration instruction, recording, in the authorization information table, a corresponding relationship among the user identifier of the data provider, the data identifier of the target data, and the user identifier of the authorized user.

Alternatively, the authorization configuration instruction further includes:
an access time limit for authorization that is used to limit an access time of the authorized user to the target data, where the authorization information table specifically records a corresponding relationship among the user identifier of the data provider, the data identifier of the target data, the user identifier of the authorized user, and the access time limit for authorization.

Alternatively, the apparatus further includes an authorization deleting module for:
receiving an authorization deleting instruction sent by the data provider, the authorization deleting instruction carrying a user identifier of the data provider, a data identifier of the target data, and a user identifier of the authorized user, wherein the authorization deletion instruction is used to instruct to delete configuration information that the authorized user is authorized to access the target data; and
in response to the authorization deletion instruction, deleting, from the authorization information table, a corresponding relationship among the user identifier of the data provider, the data identifier of the target data, and the user identifier of the authorized user.

Alternatively, for a piece of target data of the data provider, user identifiers of multiple authorized users are configured in the authorization information table.

Alternatively, the authorization information table is dynamically updated with an authorization configuration instruction sent by the data provider.

Alternatively, the target data comprises at least one column of encrypted data corresponding to a specified column identifier in at least one data table, or
the target data comprises at least one row of encrypted data corresponding to a specified row identifier in at least one data table, or
the target data comprises at least one encrypted data element corresponding a specified column identifier and a specified row identifier in at least one data table.

Alternatively, the database is deployed in a trusted execution environment.

Alternatively, the database is deployed in a trusted hardware-based trusted execution environment.

The database processing apparatus provided by embodiments of the present disclosure which can perform the database processing method provided by any of embodiments of the present disclosure includes functional modules corresponding to steps of the processing method, and can achieve the advantageous effects. The implementation principles of the two are similar, and details thereof are omitted herein.

In order to implement the above-mentioned embodiments, the present disclosure further provides a computer program product including computer programs/instructions that implement the database processing method according to the above-mentioned embodiments when executed by a processor.

FIG. 5 illustrates a schematic diagram of a structure of an electronic device provided by embodiments of the present disclosure.

FIG. 5 illustrates a schematic diagram of a structure of an electronic device 500 adapted to implement embodiments of the present disclosure. The electronic device 500 according to the embodiments of the present disclosure may include, but is not limited to, a mobile terminal such as a mobile phone, a laptop computer, a digital broadcast receiver, a Personal Digital Assistant (PDA), a tablet computer (PAD), a Portable Multimedia Player (PMP), an on-vehicle terminal (e.g. an on-vehicle navigation terminal) or the like, or a fixed terminal such as a digital TV, a desktop computer or the like. The electronic device as shown in FIG. 5 is only an example, without suggesting any limitation to the functions and the application range of the embodiments of the present disclosure.

As shown therein, the electronic device 500 may include a processor 501 (e.g. a central processor, a graphics processor or the like), which can execute various acts and processing based on programs stored in a Read Only Memory (ROM) 502 or a program loaded from a storage unit 508 to a Random Access Memory (RAM) 503. RAM 503 stores therein various programs and data required for operations of the electronic device 500. The processor 501, the ROM 502 and the RAM 503 are connected to one another via a bus 504. An input/output (I/O) interface 505 is also connected to the bus 504.

Typically, the following units may be connected to the I/O interface 505: an input unit 506 including, for example, a touchscreen, a touch pad, a keyboard, a mouse, a camera, a microphone, an accelerometer, a gyroscope and the like; an output unit 507 including, for example, a Liquid Crystal Display (LCD), a loudspeaker, a vibrator and the like; a storage unit 508 including, for example, a tape, a hard drive and the like; and a communication unit 509. The communication unit 509 can allow wireless or wired communication of the electronic device 500 with other devices to exchange data. Although FIG. 5 shows the electronic device 500 including various units, it would be appreciated that not all of the units as shown are required to be implemented or provided. Alternatively, more or fewer units may be implemented or provided.

In particular, according to embodiments of the present disclosure, the processes described above with reference to the flowchart may be implemented as a computer software program. For example, embodiments of the present disclosure include a computer program product comprising computer programs carried on a computer readable medium, the computer program containing program code for performing the method as shown in the flowchart. In those embodiments, the computer program may be downloaded and installed from a network via the communication unit 509, or may be installed from the storage unit 508, or may be installed from the ROM 502. The computer program, when executed by the processor 501, performs the above-described functions defined in the database processing method according to the embodiments of the present disclosure.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electromagnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to perform:
receiving an access request to the database, the access request carrying a user identifier of an accessor and a data processing instruction, wherein the data processing instruction is used to instruct to process specified data in the database to obtain target data, and the database is deployed in an independent, safe execution environment; in a case that a part of the target data is encrypted data, querying, based on the user identifier of the accessor, an authorization information table in the database, to detect whether the accessor is an authorized user of the part of the target data, where the encrypted data comprises data stored in the database in an encrypted form, and the authorization information table is used to record authorized user information configured by a data provider for the encrypted data; and in a case that the accessor is not an authorized user of the part of the target data, performing mask processing on the part of the target data to generate invisible masked data, and returning the masked data and remaining unencrypted target data in the target data in response to the access request. According to the embodiments of the present disclosure, the database is fully encapsulated into an independent, safe execution environment, to thus achieve integration of the database and the safe execution environment and isolate related data in the safe execution environment. In this way, data security can be ensured, the interaction between the user and the database becomes more convenient, and the data processing efficiency can be improved since the user does not need to retransmit the encrypted data, nor is the database required to perform cumbersome data interaction with other security platform. Moreover, in the present solutions, target data is determined based on a data processing instruction sent by the accessor, and then subjected to encryption detection. If a part of the target data is encrypted data, authorization detection is performed on the part of the target data based on the authorization information table of the user identifier of the accessor, and if the part of the target data fails the authorization detection, the data is fed back to the user after performing mask processing on the part of data without a view permission among the target data, thus ensuring the safety and efficiency of the data processing. In the case, unencrypted data in the target data can be fed back to the accessor, guaranteeing that unauthorized users can view some less confidential data, and improving the application flexibility of data processing scenarios.

In the embodiments of the present disclosure, computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/modules do not formulate limitation to the units per se.

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

Above described are only optimal embodiments of the present disclosure and the technical principles applied therein. It would be appreciated by those skilled in the art that the scope of the disclosure herein is not limited to the particular combination of features described above, but also encompasses other embodiments in which any combination of the features described above or their equivalents does not depart from the spirit of the disclosure. For example, the above features and (but not limited to) the features disclosed in this disclosure having similar functions are replaced with each other to form the technical solutions.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure specified in the appended claims is not necessarily limited to the specific features or acts described above. Rather, the specific features and acts described above are disclosed as example forms of implementing the claims.

1. A database processing method, comprising:
receiving an access request to a database, the access request carrying a user identifier of an accessor and a data processing instruction, wherein the data processing instruction is used to instruct to process specified data in the database to obtain target data, and the database is deployed in an independent, safe execution environment;
in a case that a part of the target data is encrypted data, querying, based on the user identifier of the accessor, an authorization information table in the database, to detect whether the accessor is an authorized user of the part of the target data, wherein the encrypted data comprises data stored in the database in an encrypted form, and the authorization information table is used to record authorized user information configured by a data provider for the encrypted data; and
in a case that the accessor is not an authorized user of the part of the target data, performing mask processing on the part of the target data to generate invisible masked data, and returning the masked data and remaining unencrypted target data in the target data in response to the access request.

2. The method of claim 1, further comprising:
in a case that the accessor is an authorized user of the part of the target data, returning the target data in response to the access request.

3. The method of claim 1, further comprising:
in a case that all of the target data are encrypted data, querying, based on the user identifier of the accessor, the authorization information table in the database, to detect whether the accessor is an authorized user of all of the target data;
in a case that the accessor is the authorized user of all of the target data, returning all of the target data in response to the access request; or
in a case that the accessor is not the authorized user of all of the target data, returning a processing failure notification message in response to the access request.

4. The method of claim 1, further comprising:
receiving an authorization configuration instruction sent by the data provider, the authorization configuration instruction carrying a user identifier of the data provider, a data identifier of the target data, and a user identifier of the authorized user, wherein the authorization configuration instruction is used to instruct to configure the authorized user to be authorized to access the target data; and
in response to the authorization configuration instruction, recording, in the authorization information table, a corresponding relationship among the user identifier of the data provider, the data identifier of the target data, and the user identifier of the authorized user.

5. The method of claim 4, wherein the authorization configuration instruction further comprises:
an access time limit for authorization that is used to limit an access time of the authorized user to the target data, wherein the authorization information table specifically records a corresponding relationship among the user identifier of the data provider, the data identifier of the target data, the user identifier of the authorized user, and the access time limit for authorization.

6. The method of claim 1, further comprising:
receiving an authorization deleting instruction sent by the data provider, the authorization deleting instruction carrying a user identifier of the data provider, a data identifier of the target data, and a user identifier of the authorized user, wherein the authorization deletion instruction is used to instruct to delete configuration information that the authorized user is authorized to access the target data; and
in response to the authorization deletion instruction, deleting, from the authorization information table, a corresponding relationship among the user identifier of the data provider, the data identifier of the target data, and the user identifier of the authorized user.

7. The method of claim 1, wherein, for a piece of target data of the data provider, user identifiers of multiple authorized users are configured in the authorization information table.

8. The method of claim 1, wherein the authorization information table is dynamically updated with an authorization configuration instruction sent by the data provider.

9. The method of claim 1, wherein
the target data comprises at least one column of encrypted data corresponding to a specified column identifier in at least one data table, or
the target data comprises at least one row of encrypted data corresponding to a specified row identifier in at least one data table, or
the target data comprises at least one encrypted data element corresponding to a specified column identifier and a specified row identifier in at least one data table.

10. The method of claim 1, wherein the database is deployed in a trusted execution environment.

11. The method of claim 1, wherein the database is deployed in a trusted hardware-based trusted execution environment.

12. An electronic device, comprising:
a processor; and
a memory configured to store instructions executable by the processor;
wherein the processor is configured to read the instructions from the memory, and execute the instructions to implement a method comprising:
receiving an access request to a database, the access request carrying a user identifier of an accessor and a data processing instruction, wherein the data processing instruction is used to instruct to process specified data in the database to obtain target data, and the database is deployed in an independent, safe execution environment;
in a case that a part of the target data is encrypted data, querying, based on the user identifier of the accessor, an authorization information table in the database, to detect whether the accessor is an authorized user of the part of the target data, wherein the encrypted data comprises data stored in the database in an encrypted form, and the authorization information table is used to record authorized user information configured by a data provider for the encrypted data; and
in a case that the accessor is not an authorized user of the part of the target data, performing mask processing on the part of the target data to generate invisible masked data, and returning the masked data and remaining unencrypted target data in the target data in response to the access request.

13. The electronic device of claim 12, wherein the method further comprises:
in a case that the accessor is an authorized user of the part of the target data, returning the target data in response to the access request.

14. The electronic device of claim 12, wherein the method further comprises:
in a case that all of the target data are encrypted data, querying, based on the user identifier of the accessor, the authorization information table in the database, to detect whether the accessor is an authorized user of all of the target data;
in a case that the accessor is the authorized user of all of the target data, returning all of the target data in response to the access request; or
in a case that the accessor is not the authorized user of all of the target data, returning a processing failure notification message in response to the access request.

15. The electronic device of claim 12, wherein the method further comprises:
receiving an authorization configuration instruction sent by the data provider, the authorization configuration instruction carrying a user identifier of the data provider, a data identifier of the target data, and a user identifier of the authorized user, wherein the authorization configuration instruction is used to instruct to configure the authorized user to be authorized to access the target data; and
in response to the authorization configuration instruction, recording, in the authorization information table, a corresponding relationship among the user identifier of the data provider, the data identifier of the target data, and the user identifier of the authorized user.

16. The electronic device of claim 15, wherein the authorization configuration instruction further comprises:
an access time limit for authorization that is used to limit an access time of the authorized user to the target data, wherein the authorization information table specifically records a corresponding relationship among the user identifier of the data provider, the data identifier of the target data, the user identifier of the authorized user, and the access time limit for authorization.

17. The electronic device of claim 12, wherein the method further comprises:
receiving an authorization deleting instruction sent by the data provider, the authorization deleting instruction carrying a user identifier of the data provider, a data identifier of the target data, and a user identifier of the authorized user, wherein the authorization deletion instruction is used to instruct to delete configuration information that the authorized user is authorized to access the target data; and
in response to the authorization deletion instruction, deleting, from the authorization information table, a corresponding relationship among the user identifier of the data provider, the data identifier of the target data, and the user identifier of the authorized user.

18. The electronic device of claim 12, wherein, for a piece of target data of the data provider, user identifiers of multiple authorized users are configured in the authorization information table.

19. The electronic device of claim 12, wherein the authorization information table is dynamically updated with an authorization configuration instruction sent by the data provider.

20. A non-transitory computer readable storage medium having a computer program stored thereon for performing a method comprising:
receiving an access request to a database, the access request carrying a user identifier of an accessor and a data processing instruction, wherein the data processing instruction is used to instruct to process specified data in the database to obtain target data, and the database is deployed in an independent, safe execution environment;
in a case that a part of the target data is encrypted data, querying, based on the user identifier of the accessor, an authorization information table in the database, to detect whether the accessor is an authorized user of the part of the target data, wherein the encrypted data comprises data stored in the database in an encrypted form, and the authorization information table is used to record authorized user information configured by a data provider for the encrypted data; and
in a case that the accessor is not an authorized user of the part of the target data, performing mask processing on the part of the target data to generate invisible masked data, and returning the masked data and remaining unencrypted target data in the target data in response to the access request.
